(19) United States
(12) Patent Application Publication
(10) Pub. No.: US 2002/0188489 A1
(43) Pub. Date: Dec. 12, 2002

(54) System and method for optimizing office worker productivity

(75) Inventors: Karen Gei-Men Cheng, Culver City, CA (US); Brenda Lynn Dietrich, Yorktown Heights, NY (US); Marco O. Gruteser, Yorktown Heights, NY (US); Anthony Levas, Yorktown Heights, NY (US); Paul Andrew Moskowitz, Yorktown Heights, NY (US); Danny Chan Yong Wong, Allendale, NJ (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 09/861,667

(22) Filed: May 22, 2001

(51) Int. Cl. G06F 17/60

(52) U.S. Cl. 705/8

(57) ABSTRACT

A method (and system and signal-bearing medium) of optimizing office worker interactions, includes assigning weight values to worker interactions, defining distances between work space locations, and calculating a placement of workers in work spaces through the application of an optimizing process using the weight values and distances.

### BACKGROUND OF THE INVENTION

1. Field of the Invention

The present invention generally relates to an office environment, and more particularly to a method and system for optimizing the placement of workers in an office environment.

2. Description of the Related Art

Office workers, particularly “knowledge workers” (e.g., inventors, scientists, engineers, researchers, thinkers, intellectual property creators, problem solvers, etc.), work most effectively when their work spaces are located in close spatial proximity with respect to the other members of their working groups.

However, a problem arises by changes in organizational structure, the ending and beginning of new projects, workers leaving the organization, new workers joining the organization, or employees desiring different office space, etc. Traditional solutions concentrate on filling vacant work spaces as they occur with workers most related to those in the vicinity of the vacant space, or by creating whole new areas when groups find that they cannot easily manage the integration of all the workers into a reasonable work space arrangement. However, the former solution is not especially successful as vacant work spaces may not be found in a reasonable period of time. The latter solution (e.g., moving whole organizations) only provides a temporary solution, as all groups (e.g., successful groups) have a tendency to become larger and larger. Moreover, a problem not addressed at all by any of the two solutions is that of locating workers who have interactions with two or more groups.

Another problem is that of “hoteling” in which office workers are assigned a new work space on a daily basis or find locations on a first come first serve basis (e.g., no fixed work space). In such a situation, there is no assurance that workers in the same group will be seated in each other's vicinity from day to day.

Thus, hitherto the present invention, while optimizing algorithms have been applied to other organizational problems such as minimizing travel costs or optimizing scheduling of workers to assignments (See, for example, U.S. Pat. No. 5,832,453, “Computer system and method for determining a travel scheme minimizing travel costs for an organization”, and U.S. Pat. No. 5,913,201, “Method and apparatus for assigning a plurality of work projects”, each incorporated herein by reference), the problem of optimizing office worker productivity and interaction (e.g., especially based on their location) has not been recognized as one to be solved by a mathematical approach.

### SUMMARY OF THE INVENTION

In view of the foregoing and other problems, drawbacks, and disadvantages of the conventional methods and structures, an object of the present invention is to provide a method and structure for optimizing office worker productivity.

In a first aspect of the present invention, a method (and system and signal-bearing medium) of arranging office workers, includes optimizing office worker interactions based on a position assigned to each of the office workers.

In another aspect, a method (and system) for optimizing office worker interactions, includes assigning weight values to worker interactions, defining distances between work space locations, and calculating a placement of workers in work spaces through the application of an optimizing process using the weight values and distances.

With the unique and unobvious aspects of the present invention, office worker productivity is optimized.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a schematic diagram of a workplace 100 including a set of offices 105 and a group of workers 140 to be assigned to individual offices according to a preferred embodiment of the present invention;

FIG. 2 is a diagram of the system 210 and its components according to the present invention;

FIG. 3 is a flowchart illustrating the method 300 of execution of the present invention;

FIG. 4 illustrates an exemplary hardware/information handling system 400 for incorporating the present invention therein; and

FIG. 5 illustrates a signal bearing medium (e.g., storage medium) 500 for storing steps of a program for optimizing office worker productivity according to the present invention.

### DETAILED DESCRIPTION OF PREFERRED EMBODIMENTS OF THE INVENTION

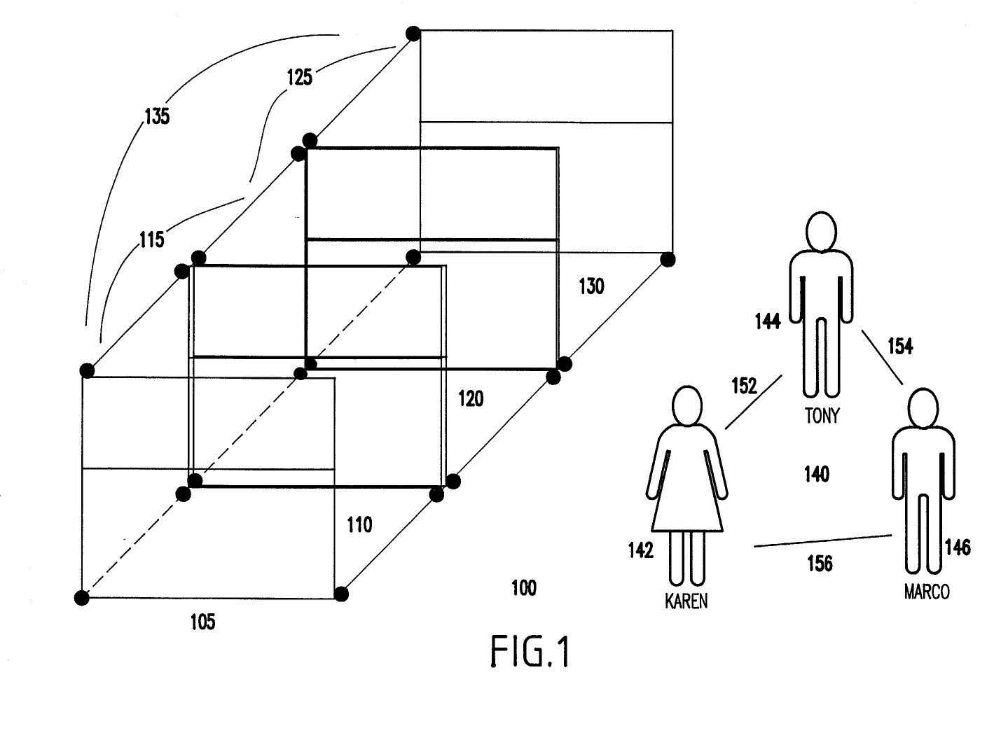

Referring now to the drawings, and more particularly to FIGS. 1-5, there are shown preferred embodiments of the method and structures according to the present invention.

### Preferred Embodiment

Referring to FIG. 1, a workplace (workspace) 100 is shown schematically. In this example, the office includes a row of individual workspaces (e.g., offices or cubicles 105). For the purpose of this example, there are three individual offices 110, 120, and 130 shown. This is the minimum number of offices needed to illustrate the present invention. Obviously, as is known, workplaces may have many individual offices arranged in two-dimensional arrays or three-dimensional arrays (e.g., on more than one level). However, the principle of the invention remains unchanged.

The distances between the offices are shown. For this example, it is assumed that the distance 115 between offices 110 and 120 is ten units, the distance 125 between offices 120 and 130 is ten units, and the distance 135 between offices 110 and 130 is twenty units. The units are units of length (e.g., feet or meters).

Also shown in the diagram is a group of workers 140. The three workers are Karen 142, Tony 144, and Marco 146. As mentioned above, the problem addressed by the present invention is to place each of the three workers in an office in such a way as to optimize the total workplace productivity by placing workers who interact with each other in close proximity.

Generally, a solution to the above-mentioned problems is a mathematical approach to calculate the optimum location of workers in work spaces by minimizing the total sum of distances between workers with the highest level of interaction.

Generally, the method works by assigning a weight between zero and 1.0 for each pair of workers, a(ij) where a is the weight and i and j are integers representing the ith and jth worker. The distance between any two worker locations, i and j, may be expressed also as a quantity d(x,ij), dependent on the assignment to offices x.

For any physical arrangement (e.g., rectangular grid, hexagonal grid, general non-periodic distribution, or three-dimensional distribution), it is possible to calculate the sum of the interaction weighting factors a(ij) multiplied by the distances between workers d(x,ij). For a three-dimensional distribution (e.g., workers on different floors) or for any other distribution, the distance used may be the actual distance traveled between offices. By minimizing the sum over all pairs, [a×d] for each (ij) where i is always less than j, an optimal office arrangement x can be obtained.

The inventive method may also take into account the beginning locations of all of the workers, and add a penalty to the sum for each worker who must move. After the calculation, workers may move to their new work spaces. Such moves may be done periodically, when new projects are formed, or when a threshold number of workers are waiting for work space assignment with their groups.

In addition, common spaces (e.g., conference areas, which are in fixed locations) may be brought into the calculation by considering them to be workers who cannot move their position.

The inventive method may take into account the effects of conflicting worker needs. Two or more workers may become less efficient when placed next to each other because they both need, for example, extensive use of a shared printer. In this case, the a(ij) strength may be negative.

For the hoteling situation, the calculation must be done over a shorter time period (e.g., daily), since the makeup of the work force can change on a daily basis.

Some workers may require fixed positions. These workers may be assigned permanent locations based upon their characteristics. For example, disabled workers (e.g., those with a physical or mental disability) may be placed close to an exit or an elevator. Managers may require (or desire) larger desks or window locations. These workers may be assigned permanent locations based upon their characteristics. Thus, additional constraints may be imposed upon the calculations by assigning fixed positions before the optimization calculation.

Each worker has some interaction with each of the other workers. However, the interactions are not all the same. In the example shown in FIG. 1, for each pair of workers i and j, an interaction weight a(ij) is assigned between zero and one.

For example, Karen spends very little time with Tony. Their interaction weight is low. Thus a(KT)=0.1. In this notation, the initials K, T, M, will stand for Karen 142, Tony 144, and Marco 146. Karen spends more time with Marco. Their interaction weight is higher a(KM)=0.5. Tony and Marco work together most of the time. They are assigned a higher interaction weight, a(TM)=0.9.

To optimize worker productivity, workers must be assigned to offices in such a way that those workers with the highest interactions are placed closest to one another. Therefore, to determine such a placement, the sum of the products of interaction weightings, a(ij), and the distances between the workers, d(x,ij) are calculated for every placement. The sum of the a(ij)×d(x,ij) products which is the smallest is the optimum distribution.

In the general case of the three-worker office, there are six possible distributions of workers to offices. However, in the case of the example of FIG. 1 in which three workers are arranged in three offices in a row, it is assumed that symmetric distributions are equivalent (e.g., a linear arrangement of Karen, Tony, Marco in that order is equivalent to an arrangement of Marco, Tony, Karen). This is generally not the case. For the general case, all possible distributions must be taken into account.

Table 1 illustrates the application of the algorithm for the example of FIG. 1.

TABLE I

| Office Number/Occupant | | | | | | |
|---|---|---|---|---|---|---|
| × 110 | 120 | 130 | a(KT)xd(x,KT) | a(KM)xd(x,KM) | a(TM)xd(x,TM) | Sum |
| (1) Karen | Tony | Marco | .1 × 10 | .5 × 20 | .9 × 10 | 20 |
| (2) Karen | Marco | Tony | .1 × 20 | .5 × 10 | .9 × 10 | 16 |
| (3) Tony | Karen | Marco | .1 × 10 | .5 × 10 | .9 × 20 | 24 |

The optimized configuration is the one for which the sum is the lowest. This is the second (2) configuration, in which Karen, Marco, and Tony are placed in offices 110, 120 and 130, respectively.

For small numbers of workers, it is possible to calculate the sum for the possible configurations as shown above. As the number of workers becomes large, it may be advantageous to perform the calculations on a computing system using an optimization technique. This problem is an example of a class of problems known as the quadratic assignment problem. One introduces a decision variable x_{p,l} for each person-location (p,l) combination. The decision variable x_{p,l} takes the value 1 if person p is assigned to location l; otherwise it takes the value 0. Two sets of constraints are required. The first set requires that each person is assigned to exactly one location; Σₗx_{p,l}=1.

The second set requires that each location is assigned at most one person: Σₚx_{p,l}≦1.

The objective is to minimize the cost, given by the objective function Σ_{p≠p′}Σ_{l≠l′}a_{p,p′}d_{l,l′}x_{p,l}x_{p′,l′}. Note that the product x_{p,l}x_{p′,l′} equals 1 if and only if person p is assigned to location l and person p′ is assigned to location l′; otherwise the product is 0. Restrictions on assignment eligibility based on status or equipment can be expressed by restricting some variables to take the value 0. Preferences can be addressed by adding a linear term to the objective function. If c_{p,l} is the cost of assigning person p to location l, then sum Σ_{p,l}c_{p,l}x_{p,l} is added to the objective function.

This problem (the quadratic assignment problem) has been addressed in the operations research literature in papers such as “The quadratic assignment problem: a survey of recent developments” by P. M. Paradalos, F. Rendl and H. Wolkowicz, in volume 16 (pages 1-42) of the DIMACS Series in Discrete Mathematics and Theoretical Computer Science, 1994, edited by P. Pardalos and H. Wolkowicz. Exact solution methods, using algorithms and software from the field of mathematical programming, have been obtained only for relatively small problems, involving up to 30 locations.

Methods for obtaining good feasible solutions, which satisfy the constraints, but not necessarily at minimum total cost, are also known, and have been successfully applied to larger problems involving over 100 locations. Such heuristic methods include simulated annealing, tabu search, local search, greedy assignments, and other iterative search methods. See, for example, “Solving quadratic assignment problems by simulated annealing” by M. R. Wilhelm and T. L. Ward, in IIE Transaction, vol.19, No 1 (1987), pp. 107-119; “Comparison of iterative searches for the quadratic assignment problem” by E. D. Taillard, in Location Science, vol 3 (1995), pp. 87-105; and “A greedy genetic algorithm for the quadratic assignment problem” by R. K. Ahuja, J. B. Orlin and A. Tiwari, in Computers & Operations Research, vol. 27 (2000), pp. 917-934.

Additional refinements to the calculations for the hoteling application may be obtained by keeping a running history of a worker's patterns (e.g., arrival/departure behavior such as, for example, the number of days stay, specific days of the week/month they tend to visit, etc.). Overtime, their associated affinity variables (e.g., affiliations, preferences, attributes such as likes, dislikes, personality characteristics, etc.) and the like may be used to assign worker ratings or constraints to fixed locations. Fixing assignments corresponds to fixing the values of some variables, and makes the resulting quadratic assignment problem smaller and easier to solve.

For example, this history may be used to derive probabilities of people with similar visiting patterns and affinity variables overlapping in time and uses these probabilities to allocate (e.g., including reserving or leaving space empty near affinity groups in anticipation of arrivals of similar affinity group members) appropriate resources (space) to them in a way that minimizes the disruption (e.g., space segmentation, blocking, etc.) caused by people that stay for longer than a day, and maximizes the probability that people of like affinity groups occupy office in close proximity (e.g., “sit together”).

Additionally, the invention uses this probabilistic information as an input to the space assignment method (algorithm) whenever it is run. It is noted that the inventive method may be run at infrequent intervals of time, daily, or even dynamically, whenever someone new arrives during the day.

Furthermore, additional constraints may be imposed to office locations to express more or less desirable offices. Because office assignments often communicate status and rewards, the invention recognizes that it is important to match “prime” office locations with higher status individuals (e.g., according to the title of a worker in a chain of supervisory authority). This may be achieved by fixing certain workers in certain locations for the calculation or by giving bonuses for such assignments. In a minimization calculation the bonuses take the form of negative quantities added to the sum.

Moreover, the invention preferably considers the personal preferences of individuals (e.g., near windows, rest rooms, elevators, etc.), with priority given to higher status individuals and people with special needs (e.g., handicapped people may need to be closer to elevators, rest rooms, etc.). Calculation bonuses may be assigned for placing certain people in or in the proximity of certain locations.

Additionally, as alluded to above, preferably the location (e.g., a laboratory, etc.) is accounted for in some way. People who work with specific equipment or office facilities found only in a specific laboratory or other location must be close to that location. Other office locations that are of importance are common spaces used by certain groups or individuals. Such common spaces may include a conference table, a projector, or a teleconferencing system. Additionally, office facilities that are located in specific office locations may include, a communications device, a copy machine, a facsimile machine, a printer, or a computer. Hence, the optimizing process is adjusted so that calculation bonuses are assigned when specific workers who need to be in the vicinity of laboratory or office space locations containing certain office facilities are placed in that vicinity. Historical use patterns of facilities may be used to determine which employees should be placed in the vicinity of those facilities.

Similarly, in order to minimize the number of workers who must move during the transition from one office arrangement to another bonuses may be assigned for workers who do not move or penalties may be assigned for workers who do move.

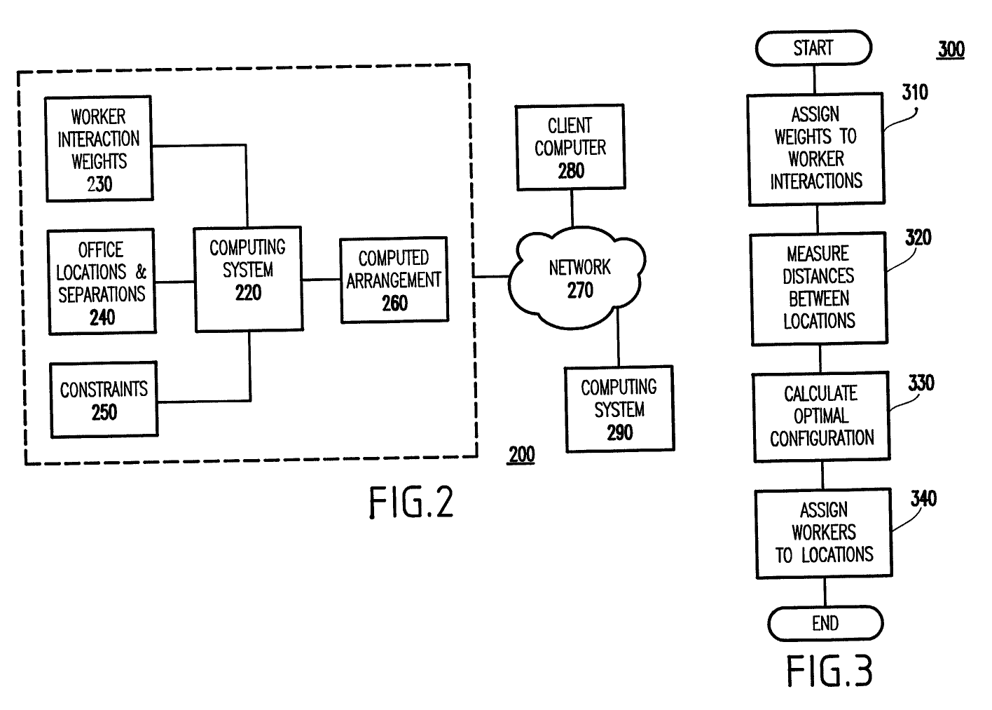

FIG. 2 shows the system 200 of the invention including the inventive apparatus (system) 210 which can be coupled to a client computer 280 and/or a computing system 290 via a network 270 (described in further detail below).

As shown in FIG. 2, the inventive system 210 includes a worker interaction weight assigner 230 for assigning weights to worker interactions. These weights may be determined automatically based upon the departmental or project assignment of a worker (e.g., workers in the same department or working on the same project have high interaction weights) based upon the frequency or duration of worker phone or e-mail communications (e.g., workers who communicate frequently or for long periods of time with each other have high interaction weights) or may be input manually. Once the weights are assigned, they may be stored in a database and updated as needed.

A distance measurement device or system (e.g., an office locations and separations measuring device) 240 is provided for measuring distances between locations (offices) in which workers are to be placed. Such a measurement device or system may consist of a computer graphics systems that provides distances between offices based upon architectural drawings. Manual input of distances may also be employed. Once distances are determined, they may be installed in a database associated with the distance measuring system 240.

Further, a constraint input device or system 250 is provided for inputting any constraints (as described above) into the computation This system may have a database associated with it for storing the constraints.

The computing system 220 receives the inputs from devices 230, 240 and 250, and computes the optimal arrangement. In this regard, it may compute the best arrangement directly or can apply the optimization technique based on the inputs of the weights, and the distances.

Finally, in unit 260, a computed arrangement is provided such that the workers are assigned to locations, thereby to arrange them in the optimal fashion.

The system 210 may be connected to a network 270. The network may be formed entirely, or in part, of components including an intranet, the Internet, or a public switched telephone network (PSTN). The network may be used to connect other computing systems 290 or client computers 280 in such a way that some or all of the inputs, computations, and results may be shared among computing systems.

Thus, turning to the flowchart of FIG. 3, the inventive method 300 may be summarized as first assigning weights to worker interactions in the group (step 310), and then measuring distances between locations (offices) in which workers are to be placed (step 320). The weights and distances may be derived for each calculation or may be obtained from databases in which they are stored.

In step 330, the optimization technique is applied based on the inputs of the weights, and the distances.

Finally, in step 340, the workers are assigned to locations, thereby to arrange them in the optimal fashion as calculated in step 330.

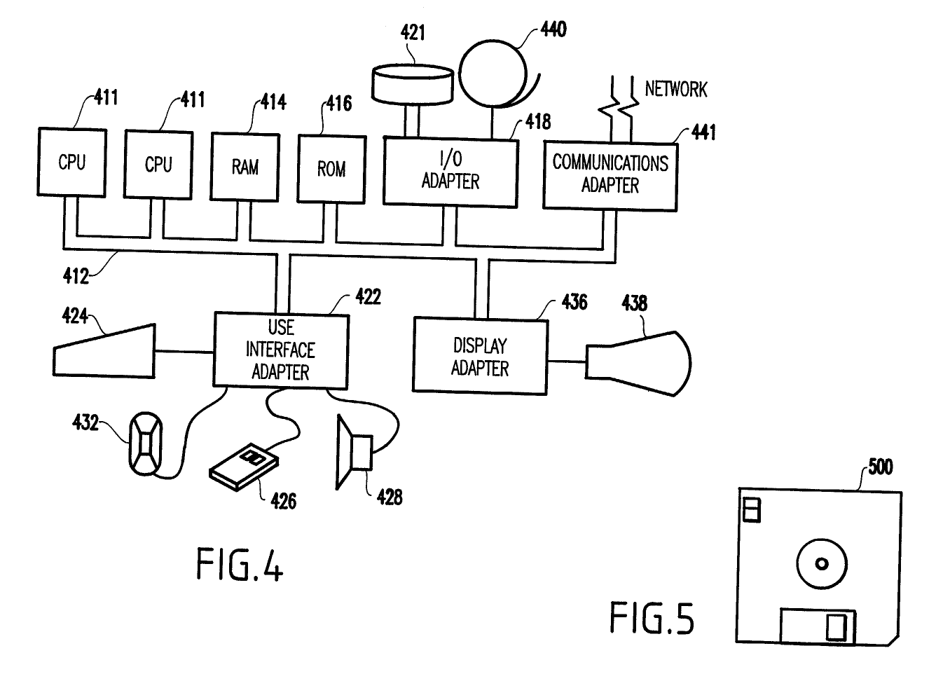

FIG. 4 illustrates a typical hardware configuration of an information handling/computer system which can be used with the invention and which preferably has at least one processor or central processing unit (CPU) 411.

The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 441 for connecting an information handling system to a data processing network, the Internet, an Intranet, a personal area network (PAN), etc., and a display adapter 436 for connecting the bus 412 to a display device 438 and/or printer (not shown).

Thus, as shown in FIG. 4 in addition to the hardware and process environment described above, a different aspect of the invention includes a computer-implemented method according to the present invention, as described above. As an example, this method may be implemented in the particular hardware environment discussed above.

Such a method may be implemented, for example, by operating the CPU 411 (FIG. 4), to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 411 and hardware above, to perform the method of the invention.

This signal-bearing media may include, for example, a RAM contained within the CPU 411, as represented by the fast-access storage for example. Alternatively, the instructions may be contained in another signal-bearing media, such as a magnetic data storage diskette 500 (FIG. 5), directly or indirectly accessible by the CPU 411.

Whether contained in the diskette 500, the computer/CPU 411, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

With the unique and unobvious aspects of the present invention, office worker productivity is optimized.

While the invention has been described in terms of several preferred embodiments, those skilled in the art will recognize that the invention can be practiced with modification within the spirit and scope of the appended claims.

It is noted that the while the example above describes three workers, the invention will work with any number of workers, offices, etc. That is, at some point as the number of workers increase, the increased computing requirement will require that the calculation be performed using linear programming techniques on an electronic computing system.

What is claimed is:

1. A method of arranging office workers, comprising:
optimizing office worker interactions based on a position assigned to each of said office workers

2. The method of claim 1, wherein said optimizing comprises:
assigning weight values to worker interactions;
defining distances between work space locations; and
calculating a placement of workers in work spaces through application of an optimizing process using said weight values and distances.

3. The method of claim 2, wherein the optimizing process is adjusted to minimize the number of workers who must move.

4. The method of claim 2, wherein the work space locations are on one of a rectangular grid, a hexagonal grid, a general non-periodic distribution, and a three-dimensional distribution.

5. The method of claim 2, further comprising:
moving workers to calculated work space locations.

6. The method of claim 2, wherein the optimizing process is adjusted to place workers in a vicinity of office spaces having office facilities.

7. The method of claim 2, wherein the calculating uses a method selected from the group consisting of simulated annealing, tabu search, local search, greedy assignments, and iterative search.

8. The method of claim 2, wherein said method is implemented as a service which may be implemented over a computer network.

9. The method of claim 2, wherein said computer network comprises one of an intranet, the Internet, and a telephone network.

10. The method of claim 2, wherein a weight value is a number in the range between zero and a finite maximum value.

11. The method of claim 2, wherein said finite maximum value is 100.

12. The method of claim 2, wherein a weight value is a number in the range between some finite minimum value and some finite maximum value.

13. The method of claim 2, wherein at least one worker location is fixed.

14. The method of claim 13, wherein the location of the fixed position is chosen based upon characteristics of the worker.

15. The method of claim 14, wherein said characteristics of the worker include at least one of a physical disability of the worker, a mental disability of the worker, the worker is a manager, a status of the worker, and a title of said worker in a chain of supervisory authority.

16. The method of claim 6, wherein said workers include at least one of workers in a work group, workers in a department, and workers needing specialized apparatus.

17. The method of claim 6, wherein said office facilities include at least one of windows, a communications device, a copy machine, a facsimile machine, a printer, a computer, a conference table, a projector, a teleconferencing system and specialized laboratory equipment.

18. The method of claim 6, wherein said office spaces include at least one of a laboratory and a common space.

19. The method of claim 2, wherein at least a portion of the results of said calculation is used for the calculations for a next time period.

20. The method of claim 2, wherein said workers are placed in work spaces such that a total workplace productivity is increased by placing workers who interact with each other in close proximity.

21. The method of claim 2, wherein an optimum location of said workers in work spaces is calculated by minimizing the total sum of distances between workers with a highest level of interaction.

22. The method of claim 21, further comprising:
determining beginning locations of all of the workers, and adding a penalty to the sum for each worker who must move.

23. The method of claim 2, further comprising:
tracking a running history of a worker's patterns such that as time elapses a worker's associated affinity variables are used to assign worker interaction weights or constraints to fixed locations.

24. The method of claim 23, wherein said patterns include any of arrival/departure behavior including any of a number of days stay and specific days of the week/month the worker tends to visit and historical patterns of facilities use.

25. The method of claim 23, further comprising:
deriving, based on the history, probabilities of people with similar visiting patterns and affinity variables overlapping in time; and
based on the probabilities, allocating appropriate resources to the workers to minimize disruption caused by a worker staying for longer than a predetermined unit of time, and maximizing a probability that workers of like affinity groups occupy office in close proximity.

26. The method of claim 25, wherein the allocating includes any of reserving and leaving space empty near affinity groups in anticipation of arrivals of similar affinity group workers.

27. The method of claim 5, wherein said moving is performed on one of a start of a new project, on a periodic basis, and when a threshold is reached.

28. The method of claim 2 wherein said weight values for said worker interactions are assigned according to at least one characteristic of said workers including at least one of a department assignment, a project assignment, phone usage, and e-mail usage.

29. A method of optimizing office worker interactions, comprising:
assigning weight values to worker interactions;
defining distances between work space locations; and
calculating a placement of workers in work spaces using said weight values and distances.

30. A system for optimizing office worker interactions, comprising:
a weight assigner for assigning weight values to worker interactions;
a distance measurement device for defining distances between work space locations; and
a calculator for calculating a placement of workers in work spaces through application of an optimizing process based on inputs from said weight assigner and said distance measurement device.

31. A signal-bearing medium tangibly embodying a program of machine-readable instructions executable by a digital processing apparatus to perform a computer-implemented method for optimizing office worker interactions, said method comprising:
assigning weight values to worker interactions;
defining distances between work space locations; and
calculating a placement of workers in work spaces through application of an optimizing process using said weight values and distances.
